(19) United States
(12) Patent Application Publication
(10) Pub. No.: US 2017/0096982 A1
(43) Pub. Date: Apr. 6, 2017

(54) Apparatus for Changing the Angle of Inclination in Wind Turbines

(71) Applicant: NABRAWIND SL, Pamplona (ES)

(72) Inventors: Eneko SANZ PASCUAL, Pamplona (ES); Hely Ricardo SAVII COSTA, Uterga (ES)

(21) Appl. No.: 15/380,727

(22) Filed: Dec. 15, 2016

Related U.S. Application Data
(63) Continuation of application No. PCT/ES2014/000106, filed on Jun. 27, 2014.

(51) Int. Cl. F03D 7/02; F03D 9/00; F03D 13/20

(52) U.S. Cl. CPC F03D 7/0204; F03D 13/20; F03D 9/002

(57) ABSTRACT

A device for changing the angle of inclination in wind turbines. According to one aspect the device is formed by a connection part having a peripheral rolling ring on which three rolling supports are arranged. The rolling supports are attached to a bench that supports the rotor of the wind turbine. Each of a plurality of plates on the bench supports at least one cylinder that operates on a piston that passes through the plate. An end of the piston is coupled to a respective one of the rolling supports in an articulated manner. The cylinders are configured to operate on the pistons to cause the bench to tilt with respect to the connection part.

### CROSS-REFERENCE TO RELATED APPLICATIONS

This application relates to and claims the benefit and priority to International Application No. PCT/ES2014/000106, filed Jun. 27, 2014, which is incorporated herein by reference in its entirety.

### FIELD

The present disclosure is encompassed in the field of wind turbines and, more specifically, the device enabling variation of the inclination angle (tilt) that the rotor axis forms with the horizontal plane.

### BACKGROUND

The rotor axis tilt was not initially intended for alignment with the wind direction. Instead it was conceived to increase the space between the blades and tower to prevent collisions. This increase is very significant upwind, since the maximum blade deflection bends toward the tower. In this case the tilt causes a certain horizontal wind misalignment, which worsens when the wind has vertical components (particularly on complex terrain). The effects are nevertheless reversed with downwind rotors. Firstly, the maximum blade deflection faces outward and the tilt is thus not as necessary. However, this angle improves alignment with vertical wind components. Consequently, the disadvantage for energy production in upwind rotors assumed because of the need for blade deflection becomes an advantage for downwind rotors and even an opportunity for additional improvement. A variable tilt that can adapt to the wind direction enables production of the maximum energy possible at all times. Therefore, having a system for actively changing the tilt provides an increase in energy production (AEP) and consequential reduction in cost of energy (COE).

In this regard, there is already known in the state of the art active tilt control systems. Therefore, the novelty does not entail controlling this tilt, but rather the mechanical solution adopted between the frame and yaw system to secure this variation in the tilt efficiently. Disclosed herein are apparatus that integrate both devices for yawing the rotor with the wind direction and varying the tilt in a single device.

The state of the art in tilt variation systems comprises a significant number of patents, though most are for upwind wind turbines and are complex control systems that take different measurements and engage the device for changing the tilt angle to improve power generation performance. In view of the foregoing, the search for background developments in this regard is limited to tilt control systems presenting some detailed solution that applies to downwind wind turbines.

U.S. Publication No. US2004/0076518 presents a solution where the tilt of the rotation axis changes and absorbs the loads produced by the gyroscopic precession of the rotor as it constantly adjusts to the wind direction. The tilting movement is executed through a ballast that hangs from the tower and supports the nacelle. It enables assembly rotation and nacelle tilting. It also permits the addition of actuators to the ballast for forcing the movement. It also incorporates a rotor speed control system for using the wind turbine's own weight as parameters for said control.

European Patent EP1683965 describes a control system and when a certain angle is established between the horizontal plane and the wind turbine rotation axis, the eccentric elements or cams (104, 105 and 106) engage the ends of the nacelle and change the tilt angle, causing the nacelle to tilt on a yaw point. This enables the nacelle to “nod” until it is aligned with the wind direction (Q), at which point yawing stops. The nacelle yawing point is on a pedestal, serving as the yaw system while also attaining the nodding movement. The eccentric elements comprise some actuators that extend and withdraw a piston. However, the system that enables the actuators to rotate according to the yawing is a complex system of notched wheels that move the nacelle (4) on the actuator support (13). The layout of the forked articulation varies the entire wind turbine and fully conditions the entire design of the nacelle or frame, greatly complicating it because it does not permit load reactions on the parts nearest the tower (outside) but rather on the central axis. This will render said structure more complicated and expensive.

### SUMMARY OF THE DISCLOSURE

According to one embodiment a wind turbine is provided is seated on a ringed transition part that fully supports the drive train. This large structure connects the lattice tower to the nacelle (as described in patent PCT/ES2014/000036), requires no pedestal and also contains the yaw rolling elements.

For changing the tilt, a device is installed in series with the rolling elements on the original structure. It is installed in the same position as the yaw system elements described, for example, in International Application No. PCT/ES2014/000037, and the yaw system and tilt may thus be integrated in a single multi-axial engagement element. Therefore, even though loads pass through this device toward the tower, there is no variation in the path of wind turbine loads. If one wind turbine version does not include the device, the rest of the wind turbine does not vary. This constitutes a design advantage in terms of versatility to possibly tailor wind turbines to the needs of the site, with or without the active system. For example, if the wind is consistently horizontal or always in the same direction, a permanent tilt or even no tilt could be incorporated. Wind turbines containing no active tilt system will have no extra cost in this regard.

Instead of nodding with two engagements on the ends and a rotation axis in the center (as disclosed in EP1683965), according to one embodiment, the new proposal suggests varying the base plane of the nacelle parallel to the rotor axis through three engagement points, which represent the minimum number for unequivocally defining a plane.

According to one embodiment the new device integrates the tilt control system and yaw system into a single element.

Three-axis ultrasonic sensors or two anemometers may be installed at the front end of the nacelle, one for measuring the horizontal component and the other for measuring the vertical component. Given that the wind turbine of the preferential embodiment is downwind, the measurements of these anemometers will not be distorted because of passage through the rotor blades, therefore increasing their measurement accuracy and, consequently, the precision of the yaw and tilt systems depending on them. Additionally, given the broad diameter of the nacelle, the distance between the sensors and rotor is longer than 15 meters and the measurement is thus taken with a certain degree of anticipation. The resulting anticipated reaction of the yaw and tilt systems will therefore enable the reduction of extreme loads caused by occasional gusts of wind and even alleviate the fatigue load spectrum compared with upwind wind turbines. These load reductions will obviously yield cost reductions for components sized to withstand said loads.

### BRIEF DESCRIPTION OF THE DRAWINGS

Below is a very brief description of a series of drawings useful for better understanding the disclosure herein. The drawings serve as mere examples.

FIG. 1 depicts a full view of a downwind wind turbine.

FIG. 2 is a perspective view of the rotor, drive train, ringed part and part of the tower according to one embodiment.

FIG. 3 is a cross-section view of the apparatus depicted in FIG. 2.

FIG. 4 depicts a detail of the yaw rolling system, delimiting its contour along a thicker line, according to the prior art.

FIG. 5a is schematic representation of a roller support element, cylinder and piston positioned to maintain the bench of the wind turbine in a horizontal position.

FIG. 5b is schematic representation of a roller support element, cylinder and piston positioned to maintain the bench of the wind turbine in a non-horizontal position.

FIGS. 6a and 6b depict engagement points of the device on the ringed part and part of the tower according to the prevailing wind.

FIGS. 7a and 7b depict embodiments respectively similar to those of FIGS. 5a and 5b with there being multiple cylinders and multiple pistons.

FIG. 8a depicts a plan view layout of the platforms supporting the engagement cylinders on the yaw system trains.

FIG. 8b shows a larger view of a platform having multiple through holes therein.

FIGS. 9a and 9b depict the cross-section of the apparatus of FIG. 3 with a tilt device located in two positions (a and b) at different angles with complementary engagement and contrary direction between the front actuator and rear actuators.

FIG. 10 depicts the use of a static solid block to alter the tilt angle according to one embodiment.

FIG. 11 depicts another embodiment in which the tilt variation system is installed between the ringed part and tower, not integrated with the yaw system but rather in series with the load path of the structure through the main legs of the tower.

FIGS. 12a and 12b are front views depicting a yaw and tilt system, wherein FIG. 12b displays an embodiment in which some pistons are replaced with guides designed to absorb horizontal or shear loads, thereby inhibiting the piston rods from bending.

### DETAILED DESCRIPTION

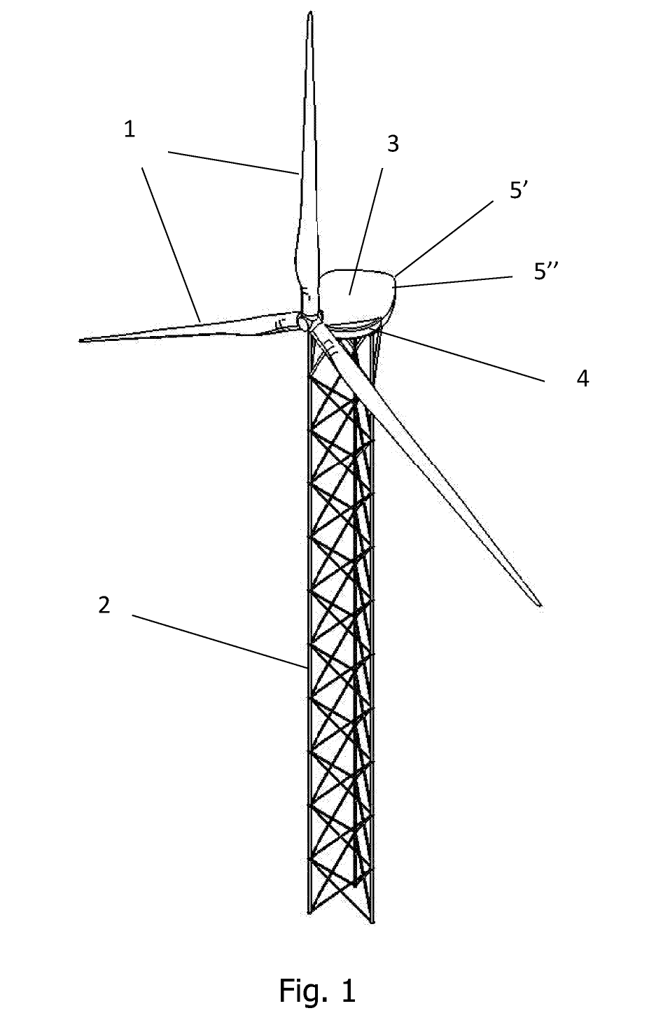

FIG. 1 illustrates a wind turbine in which a device for changing the tilt angle is installed on a horizontal axis with at least two blades 1 oriented with the wind and standing on a lattice tower 2 having three legs. There is a ringed connection part 4 between the nacelle 3 and tower 2. Two anemometers are installed at the front end of the nacelle 3, one for measuring the horizontal component 5) and the other for measuring the vertical component 5″. Measurements obtained by the anemometers may be used by a control system to control the amount the nacelle 3 is tilted with respect of the horizontal ground plane.

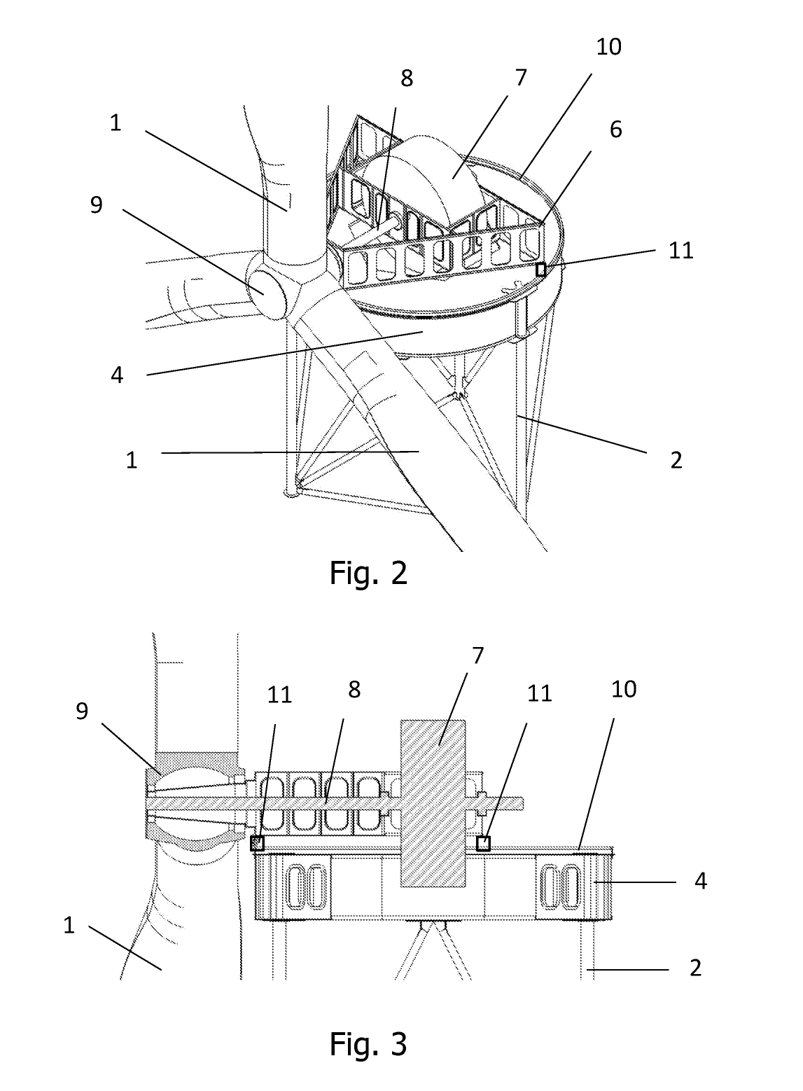

As depicted in FIGS. 2 and 3, the lattice tower 2 supports the ringed connection part 4 upon which a triangular bench 6 is seated and houses the generator 7 and main shaft 8, and supports the rotor 9 on one end. The top part of the ringed connection part 4 has a ring or rolling track 10 that forms part of the yaw system. This yaw system comprises the aforementioned ring 10 and the three rolling supports 11, each one situated on each vertex of the triangle formed by the bench 6.

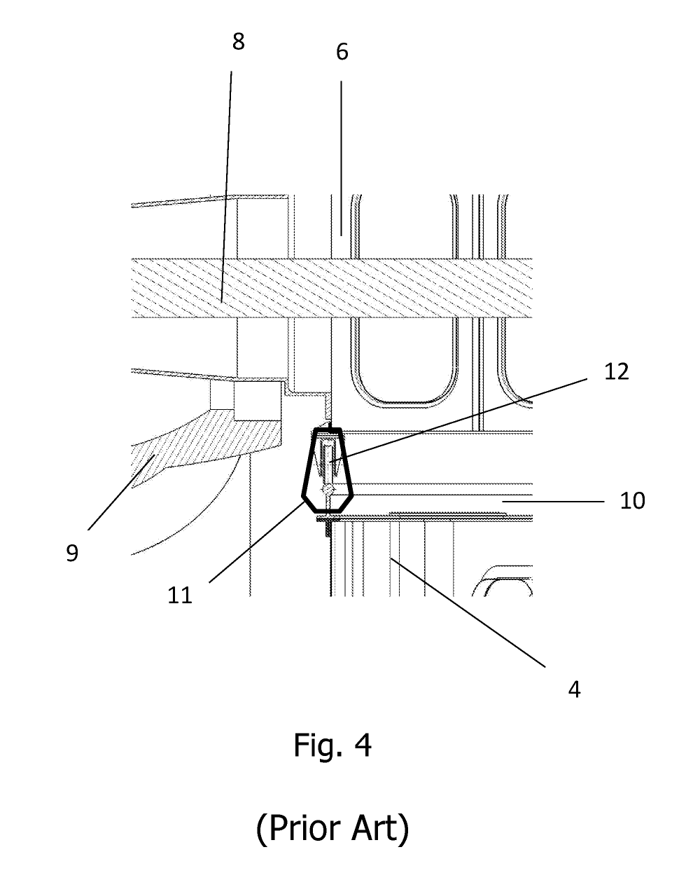

As shown in FIG. 4, the bench 6 is seated on the ringed connection part 4 through the rolling system comprising a rolling ring 10 and its corresponding rolling supports 11. The rolling ring 10 has a section that is shaped as an inverted T at the base and circular at the top. At the support point (the casing depicted with a thicker line in the image) and more specifically therein, the rolling elements 12 are shown engaging the rolling ring 10. The foregoing discussion of FIG. 4 represents the current state of the art as described in International Application No. PCT/ES2014/000037.

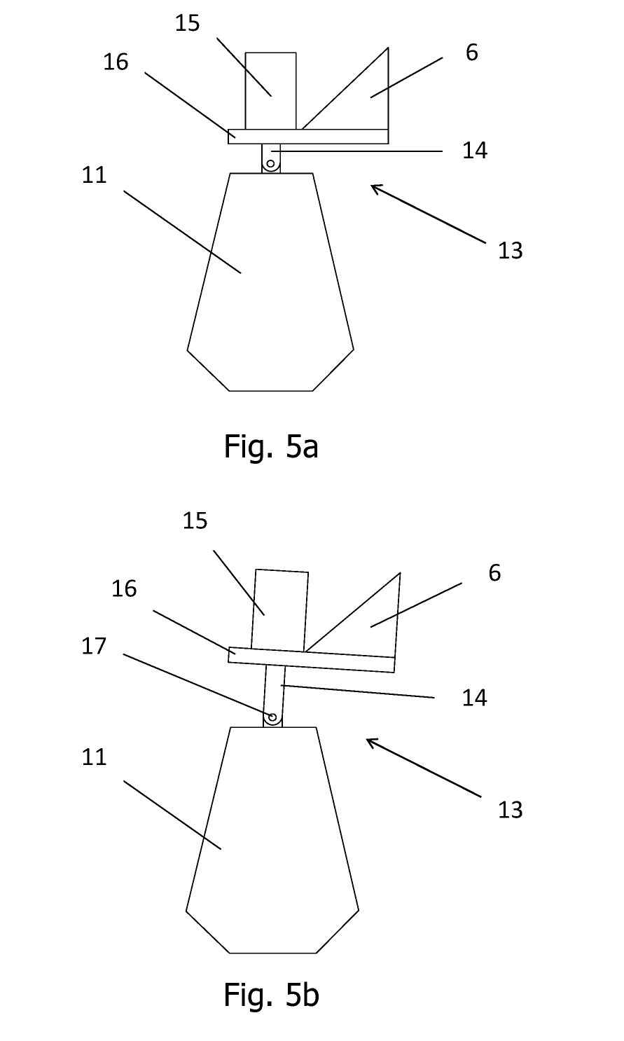

FIG. 5a depicts a casing of a roller support element 11 which includes a rolling element 12 (not shown in the figure). The roller support element 11 moves along the rolling ring (not shown in the figure) with its top connected to the bench 6 through a piston 14 that crosses a plate 16 joined to or forming a part of the bench 6 before coupling with its corresponding cylinder 15. FIG. 5b depicts how, once the cylinder 15 begins operating, the piston 14 pushes via the plate 16 coupled to the bench 6 and, as it extends, moves the bench 6 supporting the drive train, which is the moving part, at a certain angle a (tilt angle). The lower end of the piston 14 is coupled to the roller support element 11 by an articulation 17 and progressively inclines, for example, in the same measure a as the tilt angle increases. The assembly comprising the yaw rolling system and the tilt angle variation system is marked as device 13.

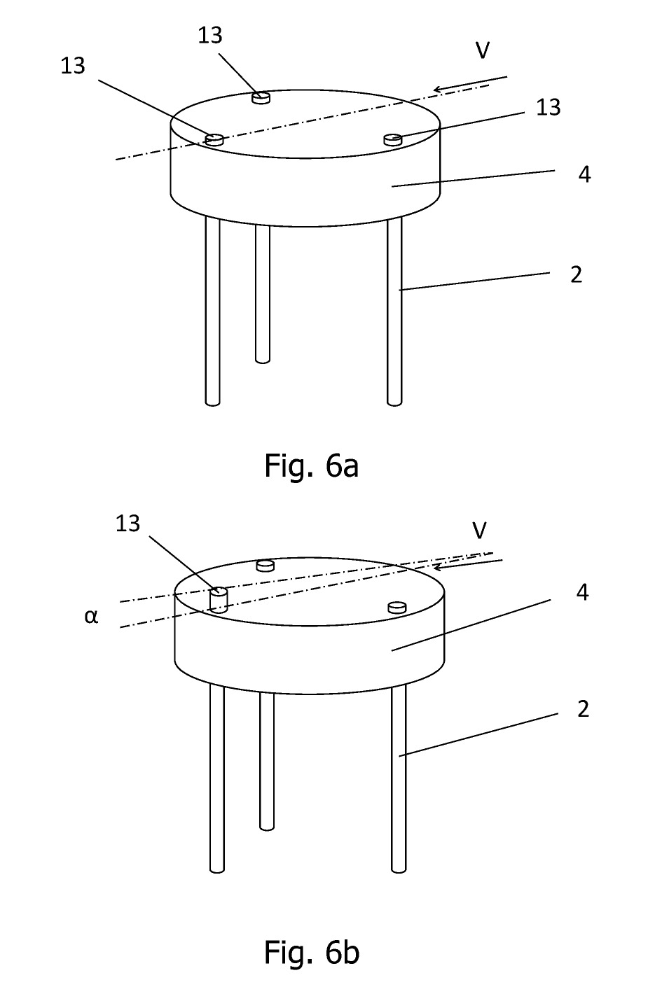

FIGS. 6a and 6b depict a schematic representation of the tower 2 supporting the connection part 4 on which there are three devices 13, each one formed by the grouping of one or more pistons and cylinders. Depending on the wind direction V, the rolling elements 12 yaw the nacelle and one of the three points on the tilt system 13 remains aligned with the wind direction V. When the wind direction changes because of the vertical wind component, the device also changes its tilt angle a. The typical starting range for the tilt angle could be ±15°. However, given that the wind direction virtually never has a negative vertical component (downward), the engagement range is more particularized between 0° and 10°. In this case, the maximum distance of the path to run per piston 14 will typically be less than 1 m, considering that the movement will always be distributed between the one or more front cylinders 15 and the two groups of one or more rear cylinders.

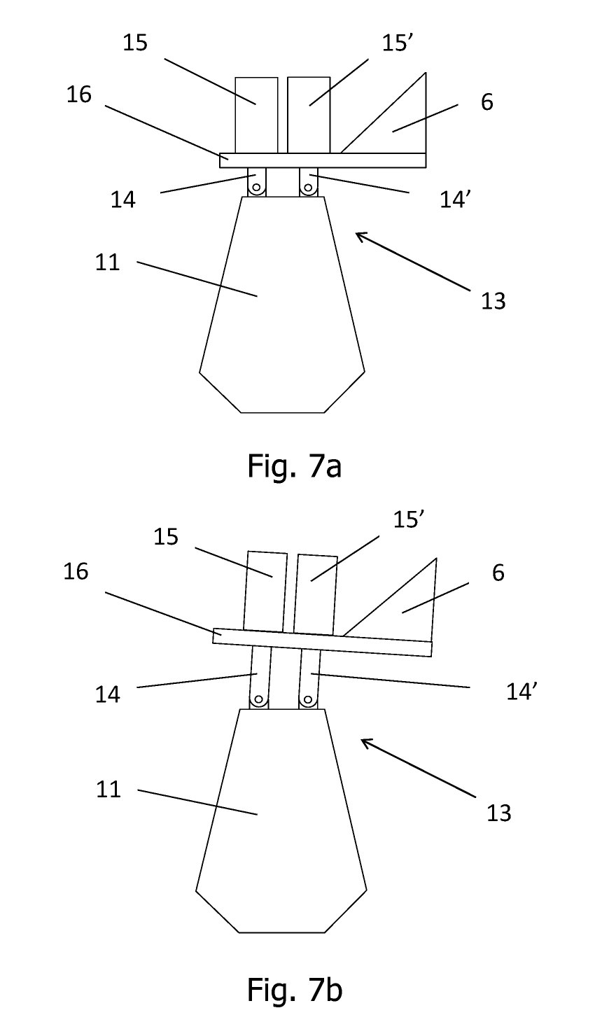

FIGS. 7a and 7b depict another embodiment for when the engagement is executed by two rows of pistons (14 and 14′) and their corresponding cylinders (15 and 15′) instead of by a single row. The group of pistons cross and the cylinders rest on their corresponding plates 16. The use of multiple rows of pistons absorbs the shear load to prevent the pistons from bending, as could be the case when using a single piston.

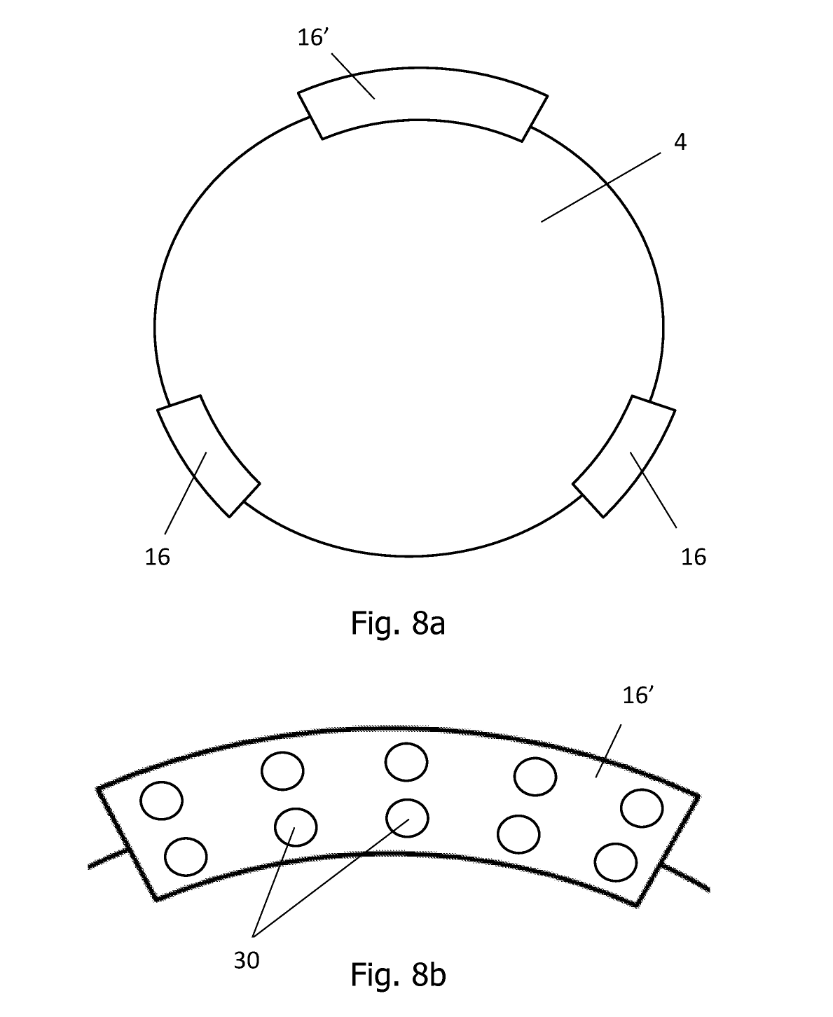

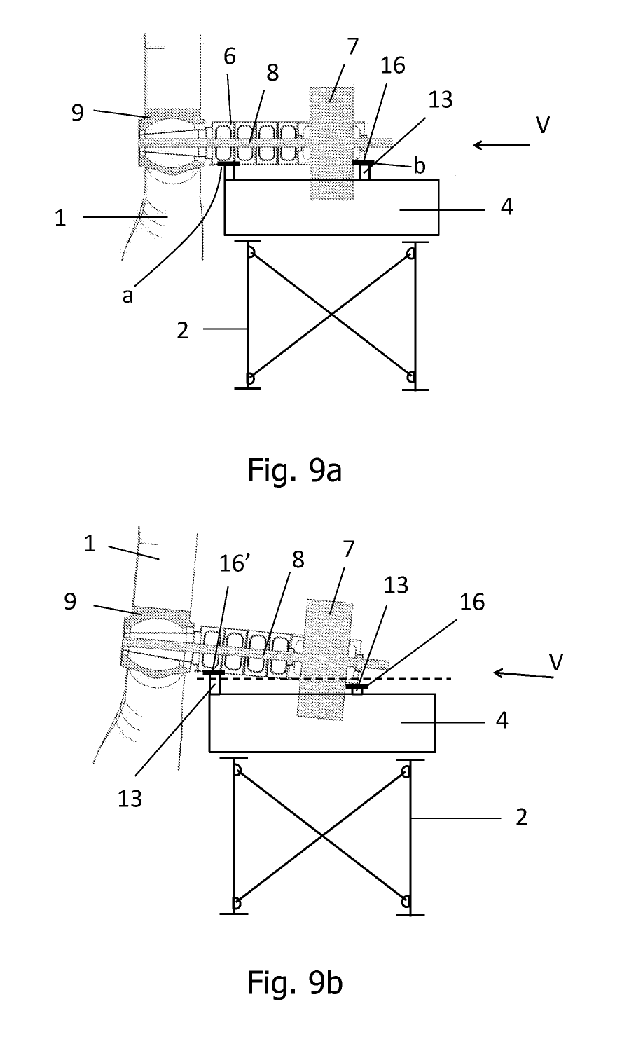

FIG. 8a depicts a plan view layout of the plates 16 according to one embodiment through which the two rows of pistons mentioned above pass when pushed by the engagement cylinders. The plate 16′ nearest the rotor is larger because it sustains a greater load than the other two plates, which accompany the operation of the first one. FIG. 8b depicts a detail of this plate 16′ with 30 holes through which the corresponding five pairs of pistons necessary to vary the tilt angle according to this particular embodiment pass, though the number of pistons in the final implementation may vary and will depend on the loads and detailed design. Thus, through the plate 16′, the device 13′ near the rotor 9 extends its pistons, the other two devices 13 retract theirs so that the tilt angle is the sum of both movements as depicted in FIGS. 9a and 9b.

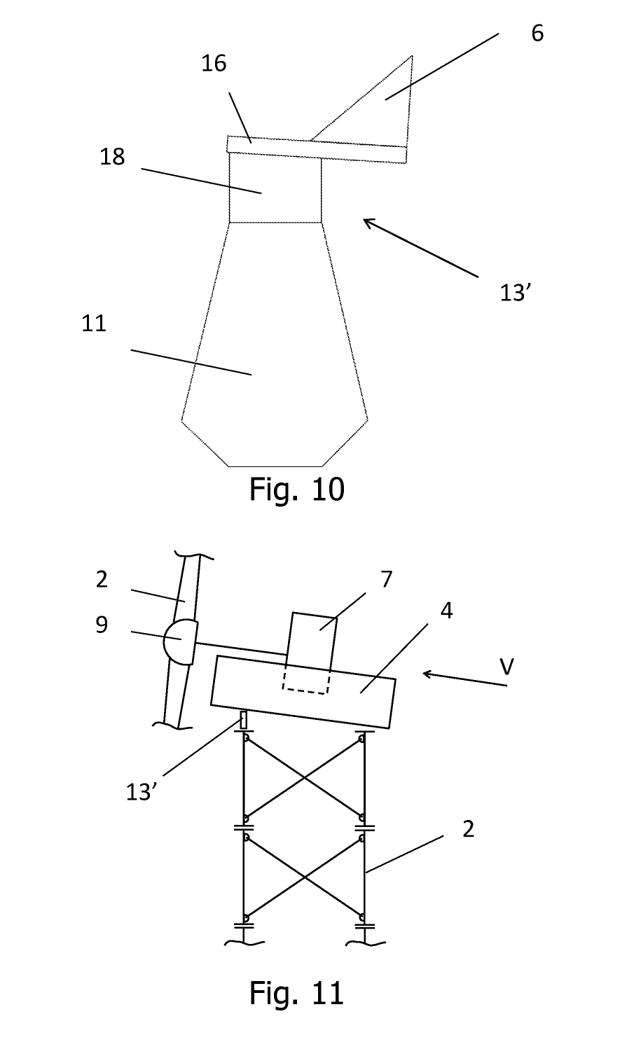

In some situations the vertical wind components are sufficiently constant so that the tilt angle variation is always the same. In this case, as shown in FIG. 10, the wind turbines could be equipped with a shim 18 installed between the rolling support element 11 and the plate 16 secured to the bench 6 that supports the drive train. In said embodiment the fixed device for adjusting the tilt angle 13′ could be installed between the ringed part 4 and the tower 2 as depicted in FIG. 11.

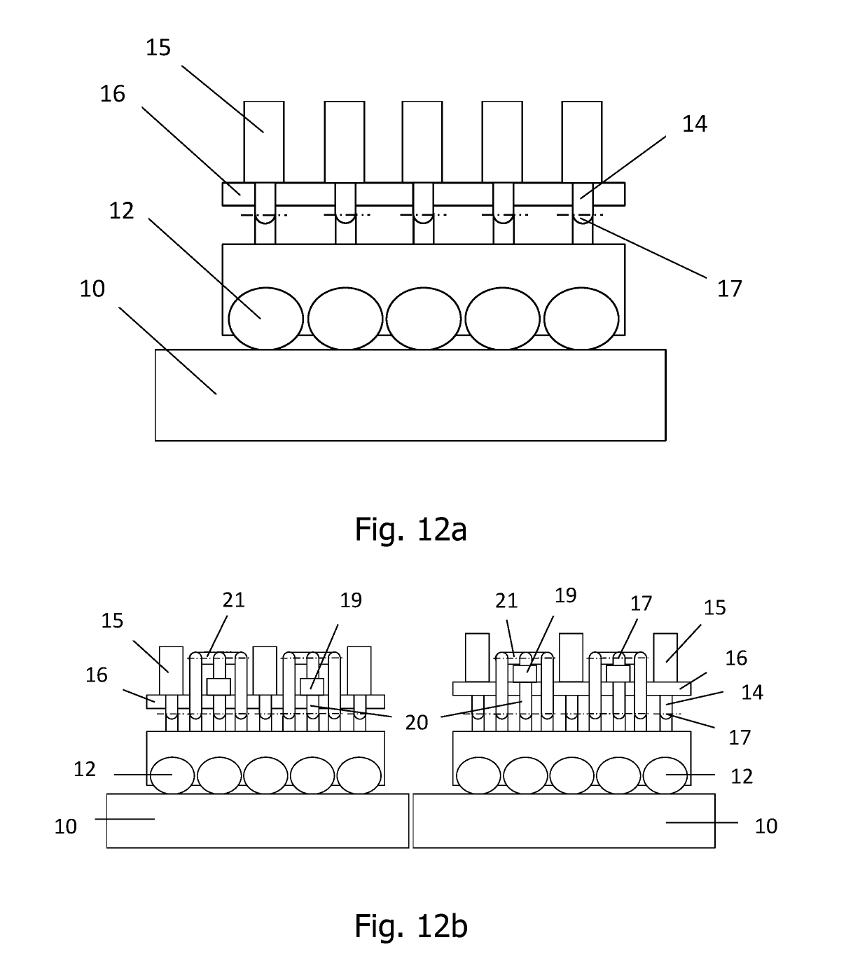

FIGS. 12a and 12b depict another alternative with guides 19 to help withstand 15 shear stress without excessively increasing the number of cylinders 15. FIG. 12b depicts how the movement is carried out, where at least two of the cylinders 15 have been replaced with some guides 19 that support at least two rods 20. The rods 20 are articulated 17 at the bottom and coupled to a rafter 21, which in turn fastens it through its own articulation 17 to the rolling support element 11 that the yaw elements contain. The rafter 21 is attached to the rolling support element 11. The guides 19 are attached to the plate 16. When engaging the tilt system, the rod 20 attached to the yaw with the articulation slides along the guide 19, enabling vertical movement while absorbing horizontal movement. This is depicted in FIG. 12b on the left, where the pistons 14 are retracted into the cylinder 15, and in FIG. 12b on the right, where the pistons 14 are extended. The rods 20 have slid compared with the guide 19) which has been raised while the rods 20 remain on the same vertical plane.

What is claimed is:

1. A wind turbine comprising:
a tower,
a generator comprising a drive shaft,
a rotor operatively coupled to the drive shaft, the rotor having a rotational axis
a bench on which is supported the generator and rotor,
an at least semi-circular support part disposed between the tower and the bench,
a plurality of rolling supports comprising rolling elements, the rolling supports interposed between the bench and the support part to facilitate a rotation of the bench in relation to the support part,
a plurality of plates that are either attached to or form a part of the bench, each of the plates comprising a plurality of through holes extending between a top and bottom surface of the plate,
a plurality of cylinders supported on the top surface of each plate, the plurality of cylinders being configured to respectively operate on a plurality of pistons that respectively extend through the plurality of through holes, each of the plurality of pistons having a top end operatively coupled to a respective one of the plurality of cylinders and a bottom end that is coupled to a respective one of the rolling supports in an articulating manner, the plurality of pistons being extendable and/or retractable by operation of the respective plurality of cylinders in order to effectuate a titling of the bench with respect to the support part.

2. The wind turbine according to claim 1, wherein the plurality of plates comprises first, second third plates equidistantly-spaced about the bench, the first plate being situated below the rotational axis of the rotor.

3. The wind turbine according to claim 2, wherein when the plurality pistons extending through the through holes of the first plate are extended and/or retracted, each of the plurality of pistons tilt progressively in the same proportion to a tilt angle of the rotational axis of the rotor with respect to the horizontal plane of the ground on which the tower is supported.

4. The wind turbine according to claim 3, wherein the degree by which the tilt angle of the rotational axis of the rotor is capable of changing with respect to the horizontal plane of the ground on which the tower is supported is no more than 15°.

5. The wind turbine according to claim 1, wherein in a first state the rotational axis of the rotor is horizontal, a length of each of the plurality of pistons extending through the through holes of the first plate is configured to change by less by no more than one meter when the rotational axis of the rotor is tilted away from the first state.

6. The wind turbine according to claim 1, further comprising at least one anemometer attached to the wind turbine, the operation of the plurality of cylinders configured to be controlled in part by a vertical wind speed component measured by the at least one anemometer.

7. The wind turbine according to claim 6 wherein the wind turbine is a downwind wind turbine.

8. The wind turbine according to claim 7, wherein the anemometer is located at least 10 meters from the rotor.

9. The wind turbine according to claim 1, wherein at least some of the plurality of pistons are arranged parallel with one another.

10. The wind turbine according to claim 1, wherein at least one of the plurality of plates comprises one or more guide holes that each extend between the top and bottom surface of the plate, a guide rod having a top end and a bottom end extends through each of the one or more guide holes, the top end of the guide rod residing above the top surface of the plate and the bottom end of the guide rod residing below the bottom surface of the plate, the bottom end of the guide rod being coupled to a respective rolling support in an articulated manner, the top end of the guide rod not being connected to a cylinder.

11. The wind turbine according to claim 2, wherein the bench has a rectangular shape that possesses first, second and third apexes, the first, second and third plates being located respectively at the first, second and third apexes.

12. A wind turbine comprising:
a tower,
a generator comprising a drive shaft,
a rotor operatively coupled to the drive shaft, the rotor having a rotational axis
a bench on which is supported the generator and rotor,
an at least semi-circular support part disposed between the tower and the bench,
a plurality of rolling supports comprising rolling elements, the rolling supports interposed between the bench and the support part to facilitate a rotation of the bench in relation to the support part,
a plate that is either attached to or forms a part of the bench, the plate comprising a plurality of through holes extending between a top and bottom surface of the plate,
a plurality of cylinders supported on the top surface of the plate, the plurality of cylinders being configured to respectively operate on a plurality of pistons that respectively extend through the plurality of through holes, each of the plurality of pistons having a top end operatively coupled to a respective one of the plurality of cylinders and a bottom end that is coupled to a respective one of the rolling supports in an articulating manner, the plurality of pistons being extendable and/or retractable by operation of the respective plurality of cylinders in order to effectuate a titling of the bench with respect to the support part.

13. The wind turbine according to claim 13, wherein the plate is situated below the rotational axis of the rotor.

14. The wind turbine according to claim 13, wherein when the plurality pistons extending through the through holes of the plate are extended and/or retracted, each of the plurality of pistons tilt progressively in the same proportion to a tilt angle of the rotational axis of the rotor with respect to the horizontal plane of the ground on which the tower is supported.

15. The wind turbine according to claim 14, wherein the degree by which the tilt angle of the rotational axis of the rotor is capable of changing with respect to the horizontal plane of the ground on which the tower is supported is no more 15°.

16. The wind turbine according to claim 12, wherein in a first state the rotational axis of the rotor is horizontal, a length of each of the plurality of pistons extending through the through holes of the plate being configured to change by no more than one meter when the rotational axis of the rotor is tilted away from the first state.

17. The wind turbine according to claim 12, further comprising at least one anemometer attached to the wind turbine, the operation of the plurality of cylinders configured to be controlled in part by a vertical wind speed component measured by the at least one anemometer.

18. The wind turbine according to claim 17, wherein the anemometer is located at least 10 meters from the rotor.

19. The wind turbine according to claim 12, wherein at least some of the plurality of pistons are arranged parallel with one another.

20. The wind turbine according to claim 12, wherein the plate comprises one or more guide holes that each extend between the top and bottom surface of the plate, a guide rod having a top end and a bottom end extends through each of the one or more guide holes, the top end of the guide rod residing above the top surface of the plate and the bottom end of the guide rod residing below the bottom surface of the plate, the bottom end of the guide rod being coupled to a respective rolling support in an articulated manner, the top end of the guide rod not being connected to a cylinder.
